(19) United States
(12) Patent Application Publication
(10) Pub. No.: US 2012/0012524 A1
(43) Pub. Date: Jan. 19, 2012

(54) Membrane bioreactor process

(76) Inventors: Chester Q. Yang, Calgary (CA); Terence K. Reid, Rockton, IL (US)

(21) Appl. No.: 12/804,142

(22) Filed: Jul. 14, 2010

(51) Int. Cl. C02F 3/12

(52) U.S. Cl. 210/603; 210/605; 210/601

(57) ABSTRACT

The inventions add a modified phase separator in the main line of a wastewater treatment process for enhanced BOD and nutrient removal with a membrane system. In addition, treatment methods and systems are described for high flux membrane filtration to meet secondary and tertiary treatment standards. Phase separation and membrane filtration techniques are employed to create concentrated return solids that are recycled in low flow volumes to reduce equipment sizing, reduce the physical space required for treatment and save energy costs without reducing treatment performance.

### FIELD OF THE INVENTION

The inventions described herein apply generally to wastewater treatment systems that employ biological processes as a treatment step and also employ one or more membranes in a filtration step. More specifically, the inventions are directed to improved methods of wastewater treatment that use phase separation, membrane filtration and recirculation controls to improve the efficiency of membrane filter operations and promote the removal of organics, nitrogen and phosphorus in activated sludge and enhance solids management in anaerobic treatment processes.

### BACKGROUND OF THE INVENTION

Since the advent of federal surface water discharge standards in the early 1970's, wastewater treatment technology has gradually developed to meet an expanding list of environmental objectives. Conventional applications of activated sludge treatment are known to be effective for removal of organic carbon, represented as biochemical oxygen demand (BOD) and, with clarification, the removal of total suspended solids (TSS) from a variety of commercial, industrial and municipal wastewaters. Additionally, selectively subjecting the mixed liquor suspended solids (MLSS) of the wastewater to aerobic (Ae), anaerobic (An) and anoxic (Ax) conditions is known by various processes in the art to be effective at removing forms of nitrogen and phosphorus (commonly referred to as nutrient removal). In most circumstances, the reduction of concentrations of BOD, TSS, nitrogen and phosphorus to predetermined levels set forth in a National Pollutant Discharge Elimination System (“NPDES”) permit grant a wastewater treatment plant operator the necessary authority under the Clean Water Act to discharge the treated waste stream into local surface water such as a river or lake.

However, many wastewater treatment plant operators are finding that discharge to surface water is not the best use of the wastewater “resource” collected. For various economic, political or environmental reasons, there is a need in the industry for additional treatment technology that improves on conventional treatment. In fact, some state and federal regulatory agencies have developed additional and more stringent treatment standards that, if met, allow other beneficial uses of treated wastewater such as reuse (for example, as irrigation water or cooling water) and pretreatment for recharge (for example, groundwater aquifer replenishment).

Although originally developed in the treatment of drinking water, it is now known in the art that membrane technology can be employed to completely remove suspended solids and provide significant reductions of certain pathogens, colloidal organic compounds and other organic and inorganic insoluble compounds from wastewater through various microfiltration, ultrafiltration and nanofiltration techniques. However, the benefit of this fine particle removal technology has substantial associated costs.

Due to the capital costs and energy requirements of membrane technology, membrane filter arrays are optimally installed in a treatment process at a location downstream of primary and secondary solids removal processes. Conventionally, it is desirable to have the influent to the membrane filter array be of low turbidity (5 NTU or less) and low suspended solids concentrations (5 mg/l or less) with little variation over time. Such an arrangement reduces the energy cost of the membrane step, reduces the required membrane filtration area and extends both the cleaning cycle and life cycle of the membranes. One example of this application is the AquaMB Process® of Aqua-Aerobic Systems, Inc. The AquaMB Process® incorporates biological treatment, secondary settling and cloth media filtration to reduce the solids that must be removed by membrane filtration. However, such multiple barrier applications require adequate physical space which may disqualify such systems from use on compact sites. Therefore there is a need in the art for a membrane filtration process that meets current and potential future effluent standards in a compact space with a low capital cost as treatment volumes increase.

It is noted that there are compact membrane filtration systems for wastewater treatment currently in use such as the Aqua-Aerobic® MBR technology by Aqua-Aerobic Systems, Inc. In such systems, the solids concentration of the influent to the membrane filter array is the same as the solids concentration in the primary treatment bioreactor, and substantially higher than the desired mixed liquor suspended solids (MLSS) concentration that optimizes membrane filtration. Consequently, for any given membrane biological reactor (MBR) system with an influent rate of 1 Q, at least 4 Q (typically 4 Q to 7 Q) is recycled from the membrane system to the bioreactor. This process results in high system wide energy demand, low membrane flux (the rate at which permeate passes through the membrane), high membrane maintenance cost and increased membrane module replacement interval. Therefore, there is a need in the art for a membrane filtration process that combines a compact site footprint with a high membrane flux rate and low energy and maintenance demands.

U.S. Pat. No. 5,942,108 (Yang) discloses a multi phase separator for concentrating recycled solids to accelerate and enhance nutrient removal within a biological wastewater treatment system. As described in the Yang reference, phase separators are intended for placement on solids-recycle streams drawn from bioreactor vessels as opposed to placement on the main treatment path. Phase separators are typically intended to operate with inlet MLSS concentrations of 4,000 mg/l-6,000 mg/l with short detention times to isolate a supernatant (subsequently treated) from the biomass in order to increase the efficiency of nitrogen and phosphorus removal. In these applications, the supernatant normally has total suspended solids (TSS) concentration of 20 mg/l-50 mg/l. However, it is a feature and an advantage of the inventions described herein that a modified phase separator can be used to condition MLSS influent to a membrane filter system and reduce the membrane recycle rate.

As discussed further herein, a modified phase separator, decoupled from its mixing element, can be repurposed to function as an additional MLSS control device. Using a modified phase separator in the main treatment path saves space over multi barrier systems by replacing a solids clarification device and a media filter with a small footprint separator at lower capital cost. Also, by reducing or discounting the conventional nutrient removal function of a phase separator, the flow-through capacity can be substantially increased making the system useful at higher hydraulic capacities. The phase separator retains its solids separation function, and reduces the MLSS concentration entering the membrane filter system. Through supplemental piping, the solids return line in a modified phase separator can be directed as needed to one or more of an anaerobic reactor, an aerobic reactor or an anoxic reactor to enhance nutrient removal capabilities. Alternatively or in combination, the wastewater influent upstream of the phase separator can be directed through anaerobic, aerobic and anoxic reactors to obtain effective nutrient removal in advance of its introduction to the phase separator. With these novel modifications, the phase separator can be applied to treat MLSS concentrations not previously thought practical.

To save additional space, reduce capital costs, and, more importantly, to enhance the total nitrogen removal, it has been discovered that aerobic and anoxic reactors can be staged in a dual use basin by the sequenced operation of aeration equipment. During the aeration phase of the cycle, conditions promote BOD removal and nitrification. During the anoxic phase of the cycle, conditions promote denitrification along with BOD removal. The staged basin can use time based cycling or instrument control based cycling (such as with a DO probe) to create an effluent with low oxidized nitrogen as an average over time. Also, the advantages of the herein described inventions are effective where a conventional sequencing batch reactor (SBR) process is employed upstream of the modified phase separator as a replacement for the staged basin. The recited advantages may be obtained from either a conventional SBR employing sequential fill, react, and discharge phases for aerated and anoxic conditions, or alternatively with a modified sequencing batch reactor (MSBR) which provides filling, reacting and discharging steps without significant water level change or valves necessary to support the batch processing.

The presently described inventions overcome limitations of current membrane treatment systems. These and other benefits of the various forms of the inventions are described in detail herein.

### SUMMARY OF THE INVENTIONS

The present inventions preserve the advantages of known membrane bioreactor techniques and also provide new features and advantages. In a primary aspect, the inventions enhance the operation of membrane filter arrays by controlling the quality of the influent to the membrane chamber. In another aspect, the inventions result in overall reduction in recycle pumping thereby improving the energy efficiency of the membrane system. Hereafter, where the specification refers to treatment reactors, chambers, vessels and the like, it will be understood to be a reference to any form of isolating the location where a treatment step takes place as those forms are known in the art. Hereafter, where the specification refers to a channel, it will be understood to be a reference to any physical conveyance (such as a pipe, trough, ditch, hose, sluice, tunnel, weir box, etc.) known in the art for the purpose of conveying a wastewater from one location to another.

In another aspect, the inventions describe the modification and repurposing of a phase separator device of the type described in U.S. Pat. No. 5,942,108 (Yang). Within the scope of the inventions described herein, a phase separator, decoupled from its mixing element, can be designed and employed in the main line of treatment between a primary biological treatment reactor and a membrane filtration chamber to control and condition the MLSS concentration that comes in contact with the membrane. Hereafter, all references to a phase separator will be understood to reference the modified version of a conventional phase separator as described above—meaning without a mixing element. The advantages of reduced size and reduced hydraulic retention time for a phase separator over conventional clarification basins also accomplishes the objective of reducing the physical space needed to meet wastewater treatment objectives. For example, the volumetric requirements for conventional secondary clarifiers following an extended-aeration activated-sludge process are often sized based upon a hydraulic retention time of 4-8 hours, whereas a phase separator requires only 0.4-1.0 hours of hydraulic detention.

In yet another aspect, the phase separator may be optionally fitted with a weir baffle and scum pipe mechanism or other debris collection equipment as is known in the art. In this configuration, the modified phase separator also acts as an added barrier protecting downstream membrane filters against debris (plastics, wood, fiber and the like) and the damaging effects of grit that may pass through the required primary treatment steps of other MBR systems. Peak hydraulic flows and open top biological reactors in conventional systems bypass grit and debris which ends up impacting the membrane filters. The supplemental grit and debris removal properties of the phase separator provide a critical back-up role to reduce membrane maintenance and extend the life expectancy of the sensitive membranes. Similarly, the phase separator may allow the use of certain ballast materials (such as magnetite) which can be used to augment the biological process but can interfere with the proper operation of membrane systems. Where such ballasted materials possess a specific gravity greater than 1.0, the phase separator can retain the ballast material thereby preventing its contact with the downstream membranes.

In combination with the modified phase separator, certain variations and sequences of anaerobic, aerobic and anoxic reactors arranged within a continuous flow treatment system are proposed for enhanced removal of nutrients and organics. Alternatively, these reactors may, in various arrangements, be implemented in a conventional sequencing batch reactor, or in a constant water level modified sequencing batch reactor or in a conventional flow-through activated sludge system or an anaerobic process. Thus the inventions provide for the treatment of a wastewater flow with membrane technology to meet secondary or tertiary effluent standards in a small physical space at a reduced cost with improved membrane flux rates, reduced operating pressures, lower maintenance costs and augmented reliability with reduced exposure to grit and debris.

### BRIEF DESCRIPTION OF THE DRAWINGS

The stated and unstated objectives, features and advantages of the present inventions (sometimes used in the singular, but not excluding the plural) will become apparent from the following descriptions and drawings, wherein like reference numerals represent like elements in the various views, and in which:

FIG. 1 is a schematic representation of a wastewater treatment process using a staged aeration basin and a phase separator, both hydraulically positioned between an anaerobic reactor and a membrane filter array.

FIG. 2 is a schematic representation of a wastewater treatment process using a staged aeration basin, a phase separator and a membrane filter array, wherein an anoxic reactor conditions returned solids from the phase separator before discharge to an anaerobic reactor.

FIG. 3 is a schematic representation of a wastewater treatment process using a staged aeration basin, a phase separator and a membrane filter array, wherein a pre-anoxic reactor conditions returned solids from the membrane filter array before discharge to an anaerobic reactor.

FIG. 4 is a typical graphic representation of the changes in the concentration levels of various nitrogen compounds over time in a staged aeration reactor (SAR), sequencing batch reactor (SBR) or a constant-level modified sequencing batch reactor (MSBR) which utilizes cyclical aeration.

FIG. 5 is a graphic representation of the changes in the concentration levels of dissolved oxygen in discreet anoxic and dissolved oxygen controlled aerobic periods over time in a staged aeration reactor, sequencing batch reactor or a constant-level modified sequencing batch reactor which utilize cyclical aeration.

FIG. 6A is a schematic representation of a wastewater treatment process using a phase separator hydraulically positioned between a sequencing batch reactor system and a membrane filter array during a react/fill phase of a first SBR cell and a react/discharge/recycle phase of a second SBR cell.

FIG. 6B is a schematic representation of a second step in the wastewater treatment process of FIG. 6A during a react/fill phase of a second SBR cell and a react/discharge/recycle phase of a first SBR cell.

FIG. 7A is a schematic representation of a wastewater treatment process using a sequencing batch reactor system and a phase separator, both hydraulically positioned between an anaerobic reactor and a membrane filter array, during a react/fill phase of a first SBR cell and a react/discharge/recycle phase of a second SBR cell.

FIG. 7B is a schematic representation of a second step in the wastewater treatment process of FIG. 7A during a react/fill phase of a second SBR cell and a react/discharge/recycle phase of a first SBR cell.

FIGS. 8A and 8B are schematic representations of a wastewater treatment process using a conventional multi-stage arrangement of aerobic and anoxic reactors with a phase separator, each hydraulically positioned between an anaerobic reactor and a membrane filter array.

FIGS. 9A and 9B are a variation of FIGS. 7A and 7B which adds an anoxic reactor to the recycle from the phase separator and operates a constant-level, continuous-flow modified sequencing batch reactor (MSBR) with cross connecting channels between the MSBR cells.

FIGS. 10A and 10B are a variation of FIGS. 9A and 9B which adds an aeration reactor which receives recycle from the membrane tank and is hydraulically positioned between the MSBR reactors and the phase separator.

FIGS. 11A and 11B depict a schematic representation of parallel MSBR reactors within a wastewater treatment process that can alternatively isolate each reactor cell from the main line of treatment to temporarily employ batch treatment within a flow-through system.

FIG. 12 is a schematic representation of an anaerobic wastewater treatment process using a phase separator hydraulically positioned between an anaerobic reactor and a membrane filter array with circulating gas from the anaerobic reactor used as a membrane scouring agent.

### DETAILED DESCRIPTION OF PREFERRED EMBODIMENTS

Set forth below is a description of what is currently believed to be the preferred embodiments or best representative examples of the inventions claimed. Future and present alternatives and modifications to the embodiments and preferred embodiments are contemplated. Any alternatives or modifications which make insubstantial changes in function, purpose, structure or result are intended to be covered by the claims of this patent. Where references in the specification are made to a numeric concentration for a specific wastewater characteristic (such as MLSS), the concentration is intended to be understood as an average concentration over time (in hours or days) as opposed to an instantaneous or episodic concentration value.

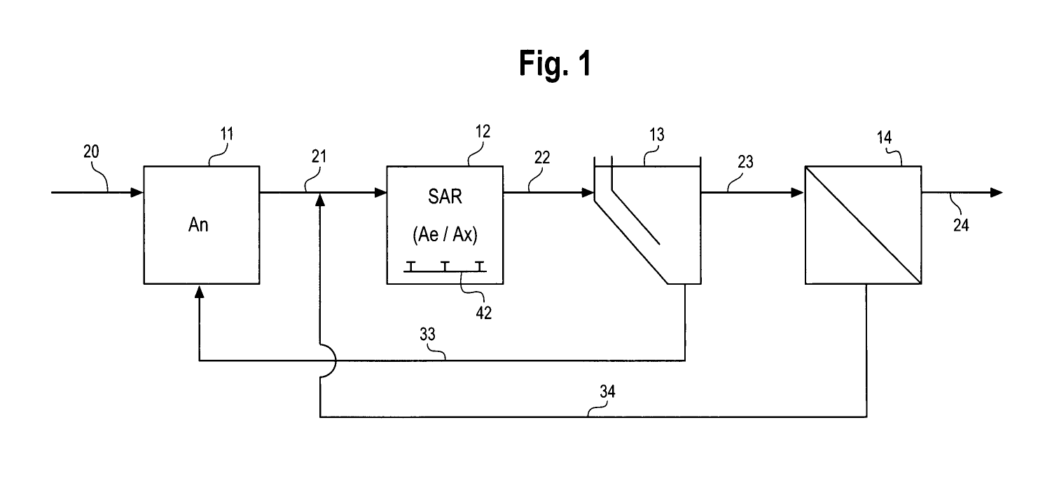

FIG. 1 shows a schematic diagram of a wastewater treatment process according to one of the preferred embodiments of the invention. On the primary treatment path, the process employs an anaerobic reactor 11, a staged aerobic/anoxic or aeration reactor 12, a phase separator 13 and a membrane filter 14. Typically a screened and de-gritted wastewater enters anaerobic reactor 11 via influent channel 20 where it interacts with an activated sludge biomass (not shown) in the presence of one of a variety of non-aerating mixing devices as known in the art, such as an AquaDDM® mixer by Aqua-Aerobic Systems, Inc. Anaerobic reactor 11 promotes the growth of phosphorus accumulating organisms (PAO). Enhanced biological phosphorus removal is expedited in the absence of significant levels of dissolved oxygen and oxidized forms of nitrogen.

Facultative bacteria present in anaerobic reactor 11 produce acetate and other fermentation products which are then used as substrate by the PAO. By increasing the MLSS concentration in sludge return line 33 in comparison to the MLSS concentration in reactor 11, less treated liquid (containing little or no organic carbon) is returned to the anaerobic cell 11.

Increasing the organic carbon concentration (which could, equivalently, be understood as limiting the volume of diluted liquid in sludge return line 33) reduces the quantity of oxidized nitrogen being returned to the anaerobic cell 11, promoting a purer anaerobic condition.

Limiting the volume of diluted liquid introduced to the anaerobic cell 11, also increases the actual hydraulic retention time which, in turn, encourages the fermentation of volatile fatty acids (VFA) from the non-VFA organic carbon. A byproduct of this process is the substantial release of phosphorus from the cell mass into a soluble form. Optionally, a monitor can be placed to sample phosphorus concentrations in anaerobic reactor 11 to indicate the rate of increase of phosphorus released into the basin from the interaction over the contribution of phosphorus present in the influent channel 20.

The effluent from anaerobic reactor 11 is conveyed to a staged aeration reactor 12 via channel 21. A fully mixed environment is maintained in the staged aeration reactor 12 by one of a variety of non-aerating mixing devices as known in the art such as an AquaDDM® mixer by Aqua-Aerobic Systems, Inc. In addition, the staged aeration reactor 12 is equipped with an aeration system, preferably a fine bubble aeration system such as one of the Endura® series aeration systems of Aqua-Aerobic Systems, Inc. The staged aeration reactor 12 also receives concentrated return solids from membrane reactor 14 via return channel 34. The combined mixed liquor sources from channel 21 and return channel 34 preferably are operated to create and maintain a MLSS concentration of approximately 5,000-10,000 mg/l in staged aeration reactor 12.

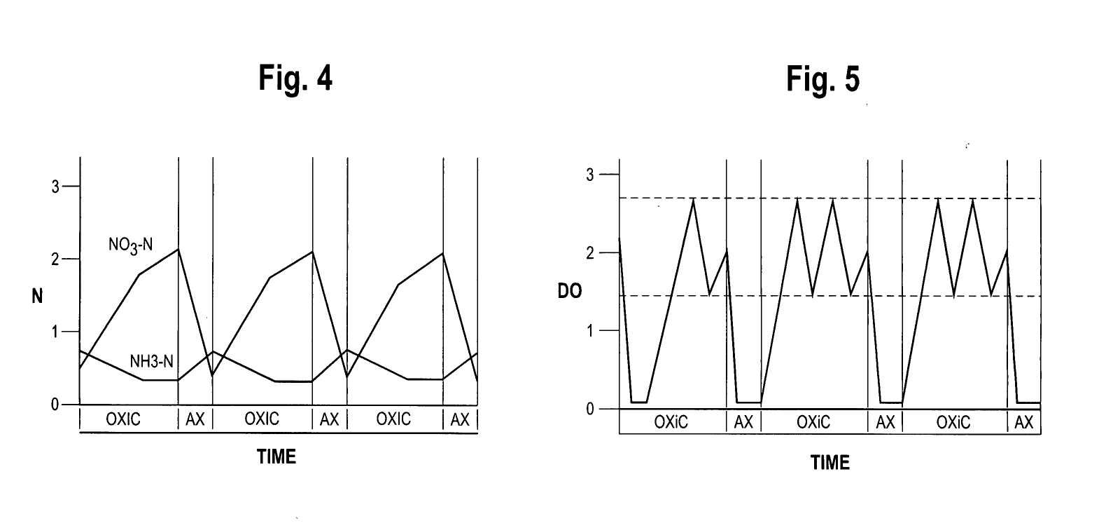

Instrumentation and controls associated with the staged aeration reactor 12 selectively cycle the aeration system on and off in repeating intervals to create alternating aerobic and anoxic conditions in the reactor 12 (see also, FIGS. 4 and 5). Under aerobic conditions in reactor 12, nitrification is promoted, organic carbon is converted to carbon dioxide, water and additional biomass; and phosphates are taken up by the biomass, particularly through interaction with PAO. Under anoxic conditions in reactor 12, denitrification is promoted (increasing as MLSS concentration increases), and the mixed liquor solids are phosphate rich. Although BOD₅ reduction is exhibited under aerobic and anoxic conditions, the rate of BOD₅ reduction is greater during the aerated periods of operation.

The influent of channel 21 enters the reactor with a certain potential oxygen demand. The oxygen demand is created by the aerobic metabolism of the organic constituents (i.e. BOD₅ reduction) and the nitrification of ammonia nitrogen (NH₃—N). The aeration system is sized to meet this oxygen demand. A dissolved oxygen (DO) concentration profile like that of FIG. 5 will normally indicate a pattern of increasing DO concentration during aerated periods, followed by decreasing DO values (to near zero) during non-aerated periods. Typically, the DO concentration will reach a peak value at the end of each aeration period as shown in FIG. 5.

Cycling of the staged aeration reactor 12 may be time based or event based. Preferably, time based cycling is employed by switching the aeration equipment on and off at regular intervals. The DO profile can be managed by providing discreet control (on/off) of the aeration system 42 or by use of variable frequency drives (VFD) on the aeration system blowers to target a specific DO value at any given time during the oxic (aerated) periods. Upon termination of the aeration period, the resulting depletion rate of DO concentration can be monitored as representative of the oxygen uptake rate (OUR) of the reactor 12. DO probes, redox/ORP probes and similar monitoring devices as are known in the art may be installed in reactor 12 or on a sampling line from reactor 12 to track the changes in DO concentration over time.

For most wastewaters, it is preferred to operate in one hour cycles with approximately 75% of the cycle in aerobic conditions and 25% of the cycle in anoxic conditions. Event based cycling may be linked to concentrations of dissolved oxygen, nitrates or ammonia nitrogen through the use of various probes or sampling of the mixed liquor in the reactor 12. Whether event based or time based, the treatment objective in the staged aeration reactor is to obtain an effluent in channel 22 that is low in oxidized nitrogen when averaged over time (see FIG. 4).

The mixed liquor effluent from staged aeration reactor 12 is conveyed to a phase separator 13 via channel 22. Phase separator 13 is modified from conventional design. Modifications to phase separator 13 include functionally decoupling the unit from any mixing or aeration equipment. Further optional modifications include adding scum removal equipment (not shown) such as a baffle at the outlet weir box and a scum pipe or similar removal equipment as is known in the art.

The phase separator 13 creates a low energy environment that results in two discharges with different properties. The supernatant overflow drawn off through channel 23 to the membrane reactor 14 is comparatively low in suspended solids with low concentrations of settleable solids. When the optional scum removal equipment is used, the supernatant is also low in scum, grease and floatable debris. Phase separator 13 also has a second discharge via return solids channel 33 which conveys a thickened sludge back to anaerobic reactor 11. Thickened sludge is typically conveyed by one of a variety of sludge pumps which are well known in the art for that purpose. The phase separator 13 is preferably sized and configured to remove greater than 70% of the total suspended solids from staged aeration reactor 12 through channel 33. For most typical wastewaters treated by the process described herein, the total suspended solids in channel 23 and subsequently introduced to the membrane reactor 14 represents less than 50-250 mg/l (based on an approximate flow split of 70% exiting phase separator 13 through channel 23 and 30% of the flow through channel 33). In applications which may utilize coagulants (such as aluminum sulfate) for supplemental phosphorus removal or other chemicals to enhance membrane flux, introduction through channel 22 prior to the phase separator 13 will reduce the solids and chemical loading to the membranes.

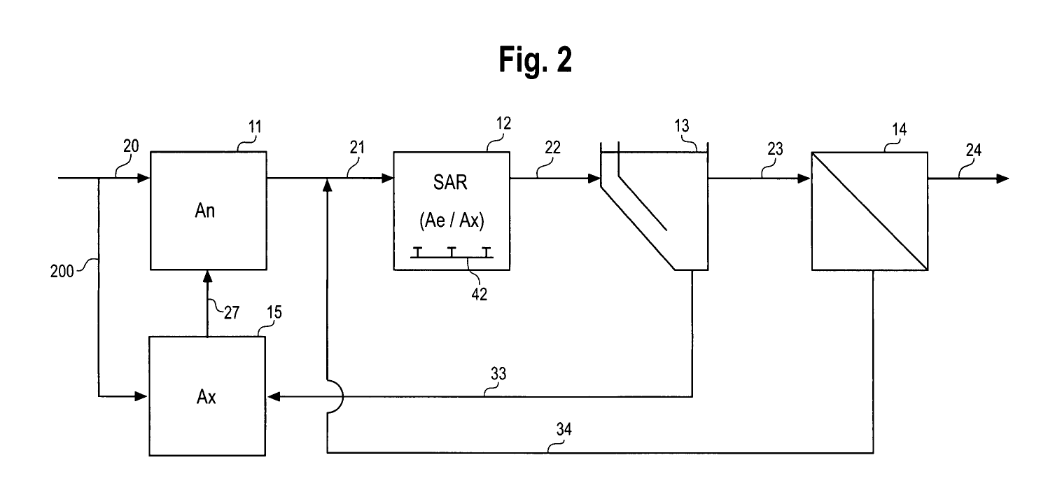

In an alternative embodiment shown in FIG. 2, return solids channel 33 may route the solids from phase separator 13 to an anoxic reactor 17. Anoxic reactor 17 is maintained in an anoxic condition for additional denitrification and for the reduction of dissolved oxygen prior to returning the solids to anaerobic reactor 11 via channel 27. Anoxic reactor 17 may also be used to condition a portion of the system influent upstream of anaerobic reactor 11. Incoming flow in channel 20 may be split with a portion diverted directly to anoxic reactor 17 via channel 200 prior to being introduced into anaerobic reactor 11 for treatment. Diversion through channel 200 is appropriate when nitrate levels in channel 20 are high. At conventional nitrate levels, channel 200 is normally closed.

The membrane reactor 14 receives the supernatant effluent from phase separator 13 via channel 23. Preferably, the submerged membrane filtration system of reactor 14 employs a hollow fiber membrane system, (for example, the PURON™ membranes manufactured by Koch Membrane Systems) and is configured for an outside-in flow path. The PURON™ membrane is a polyethersulfone, hollow fiber, membrane cast onto a braided support and potted at one end of each fiber bundle. The supernatant effluent from phase separator 13 is introduced to the outside of the hollow membrane fibers present in membrane reactor 14. A vacuum pressure is applied to the inside of the fibers by a vacuum pump or other means as are known in the art to draw a filtrate (or permeate) from the outside of the fiber to the inside. Preferably, the nominal pore size of the membrane fibers is approximately 0.05 microns. However, pore sizes may vary through the full range of microfiltration, ultrafiltration and nanofiltration membranes indicated for use in wastewater applications. Other membrane filtration equipment, pumping systems and procedures as are known in the art may be substituted without departing from the scope of the inventions.

In a preferred embodiment, the potted end of each fiber bundle is fixed in a foot element, with a central air nozzle to inject air into the center of the bundle on the outside of the fibers. The shear force of the injected air scours the membrane surface removing deposits from the membrane. Module sludging and clogging, noted in other systems, is largely avoided. Air injection is in operation during the production mode of the membrane filters, and may be continuously or intermittently operated. Periodically the membranes may be back-flushed to remove accumulated surface-deposits that have reduced the membrane flux rate. During membrane back-flushing, filtered permeate is pumped in a reverse direction through the membranes in conjunction with the air scouring operation. During conditions where the influent flow 20 is below design capacity, the membranes can be operated in a relaxation state where flow is not passing through the membrane in either a forward or reverse direction, for a limited period, as a method for improving membrane performance. During such a membrane relaxation mode, the phase separator 13 can be similarly controlled whereby flow is neither entering nor exiting the basin by providing proper isolation of the membrane recycle function, resulting in improved performance by increasing the concentration of suspended solids in the underflow stream 33. Chemical cleaning may also be periodically indicated when membrane fouling is attributable to biological films or adsorbed substances.

The membrane reactor 14 is a physical barrier to suspended solids and microorganisms which replaces a clarification step and/or a filtration step in conventional treatment processes. In a preferred embodiment, channel 23 includes a distribution manifold located at the bottom of reactor 14 so that the flow path is from the bottom to the top of the membrane fiber bundles. Typically, the manifold allows for even distribution of the influent across the full horizontal dimensions of membrane reactor 14.

The mixed liquor which does not pass through the membrane of reactor 14 accumulates solids and is discharged as the retentate of the membrane reactor 14 through solids return channel 34 to the staged aeration basin 12. Given the pore size of the membrane and the higher flux rate obtained by using an influent with a lower MLSS concentration, the solids inventory in membrane reactor 14 increases rapidly and concentrates at a solids collection point (not shown) for discharge through solids return channel 34. In normal operation of this embodiment, the MLSS concentration in solids return channel 33 is approximately 1.5% to 2.5% suspended solids. Due to the lower MLSS concentration in feed channel 23, for any given influent Q, the typical recycle rate from membrane reactor 14 is only 0.5 to 2 Q rather than the normal 4 Q to 7 Q at higher feed concentrations of conventional membrane filtration applications. Additionally, the lower solids input to membrane reactor 14 results in a lower suspended solids concentration from the membrane reactor 14 through solids return channel 34 of approximately 600-1,000 mg/l as compared to conventional values of 10,000 to 20,000 mg/l.

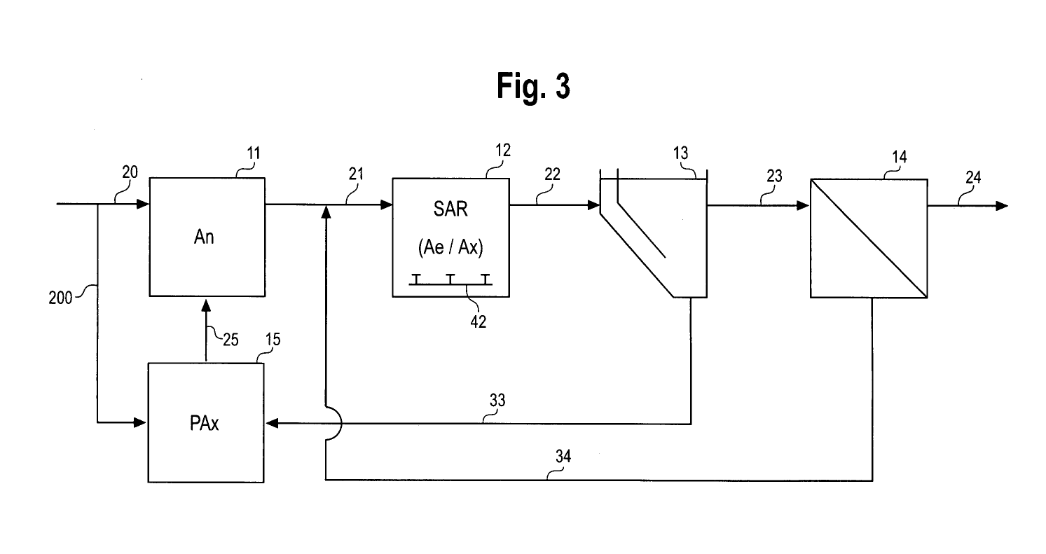

In an alternative embodiment as shown in FIG. 3, solids return channel 34 may be routed from the membrane reactor 14 to a pr e-anoxic reactor 15. Pre-anoxic reactor 15 is maintained in an anoxic condition for additional denitrification, for pre-fermentation in aid of the phosphorus removal process and for the deoxygenation prior to returning the solids to anaerobic reactor 11 via channel 25. Pre-anoxic reactor 15 includes a non-aerating mixer such as an AquaDDM® mixer by Aqua-Aerobic Systems, Inc. Pre-anoxic reactor 15 may also be used to condition a portion of the system influent upstream of anaerobic reactor 11. Incoming flow in channel 20 may be split with a portion diverted directly to pre-anoxic reactor 15 via channel 200 prior to being introduced into anaerobic reactor 11 for treatment. Under this alternative arrangement, the solids discharge from phase separator 13 is conveyed to the staged aeration reactor 12 via return channel 33. In general, the embodiment of FIG. 2 is preferred over the embodiment of FIG. 3. If the influent waste characteristics exhibit a high influent organic acid concentration, the embodiment of FIG. 3 is preferred over the embodiment of FIG. 2. If the solids concentration of channel 23 is normal to high, the embodiment of FIG. 2 is preferred over the embodiment of FIG. 3.

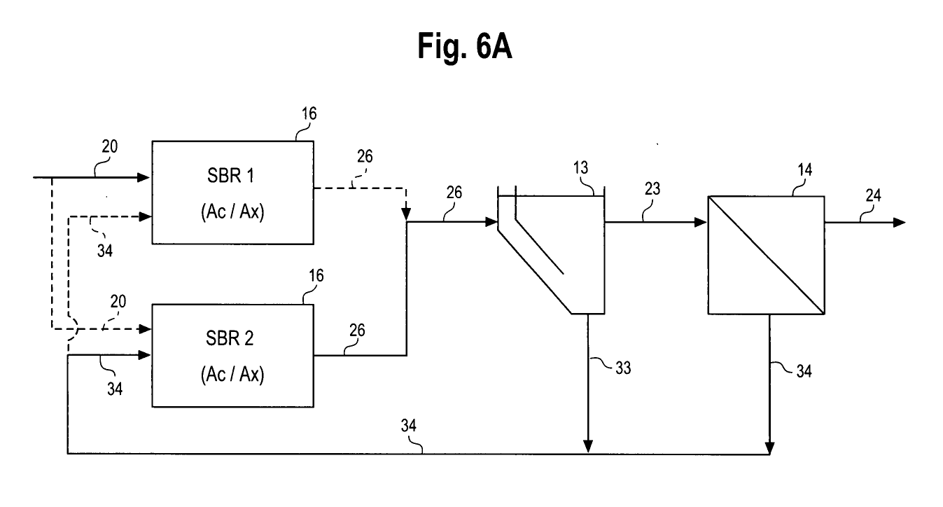

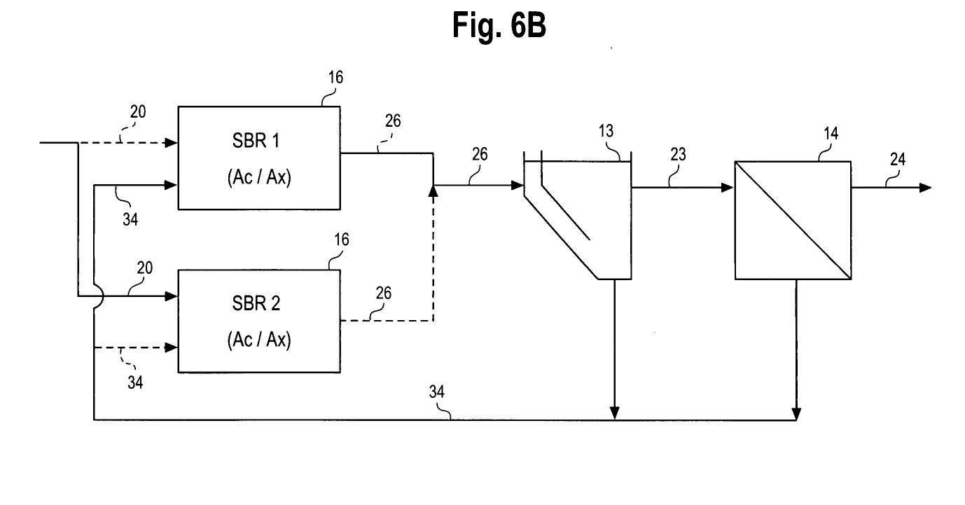

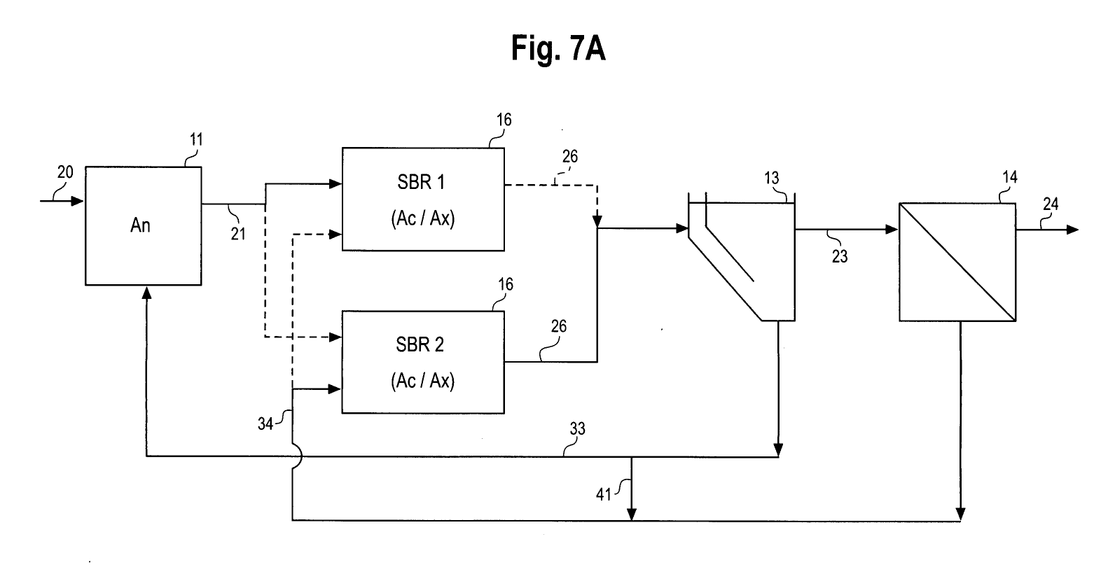

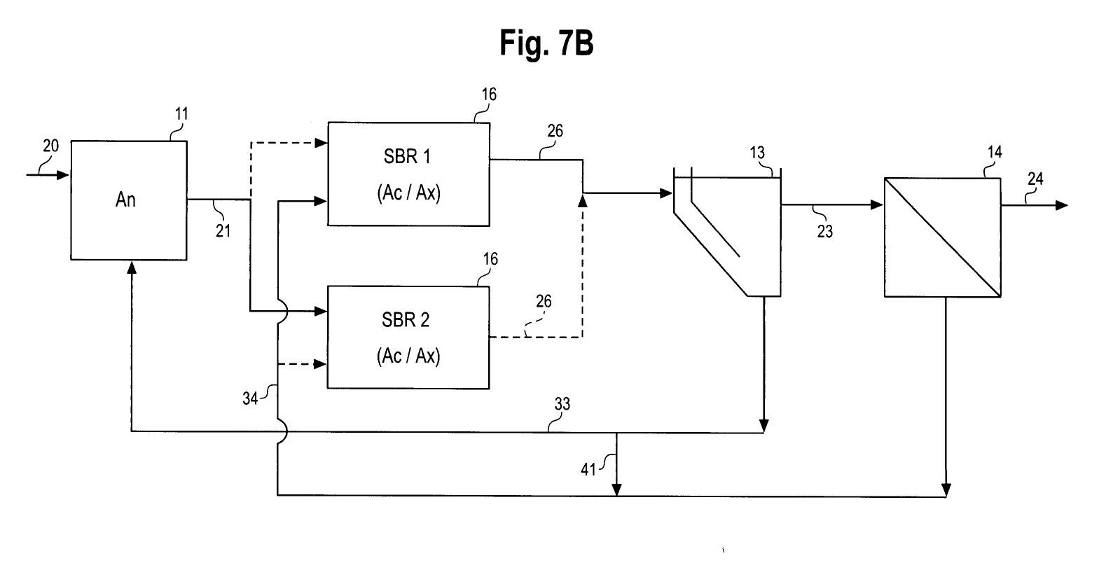

In another alternative embodiment, staged aeration reactor 12 may be replaced with a pair of sequencing batch reactors (SBRs) 16. In the absence of anaerobic reactor 11, FIGS. 6A and 6B illustrate a pair of SBRs 16, each operating in three cycled phases including an aerobic phase, an anoxic phase and an anaerobic phase. The SBRs are operated on opposing cycles with SBR1 16 in react/fill mode while SBR2 is in react/discharge/recycle mode. As with staged aeration reactor 12, each SBR unit 16 is equipped with an aeration system 42 (not shown) which operates in the same manner as the aeration system of staged aeration reactor 12. The react phase of each SBR 16 is operated in a manner consistent with the cycled sequence of aerobic and anoxic phases described for the staged aeration reactor 12, with the addition of an anaerobic phase to replace the function of anaerobic reactor 11.

Where a separate anaerobic reactor 11 is desired or available for use with a SBR process, FIG. 7A shows a first SBR1 16 operating in react/fill mode while receiving influent from anaerobic reactor 11 via channel 21 (shown in solid line). A broken line in FIG. 7A from channel 21 to a second SBR2 16 indicates that flow from anaerobic reactor 11 to the second SBR2 16 is stopped. At the same time in the treatment process, the second SBR2 16 is discharging to phase separator 13 via channel 26 (shown in solid line). A broken line in FIG. 7A from a first SBR1 16 to channel 26 indicates that flow out of the first SBR1 16 is stopped.

In the embodiment of FIGS. 7A and 7B, solids return lines 33 and 34 are cross connected via channel 41 through any one of the various means that are generally known in the art. Cross connection channel 41 permits the combination of the solids discharges of phase separator 13 and membrane reactor 14 in various proportions to allow proper control the MLSS concentration returned to the anaerobic reactor 11 and SBRs 16.

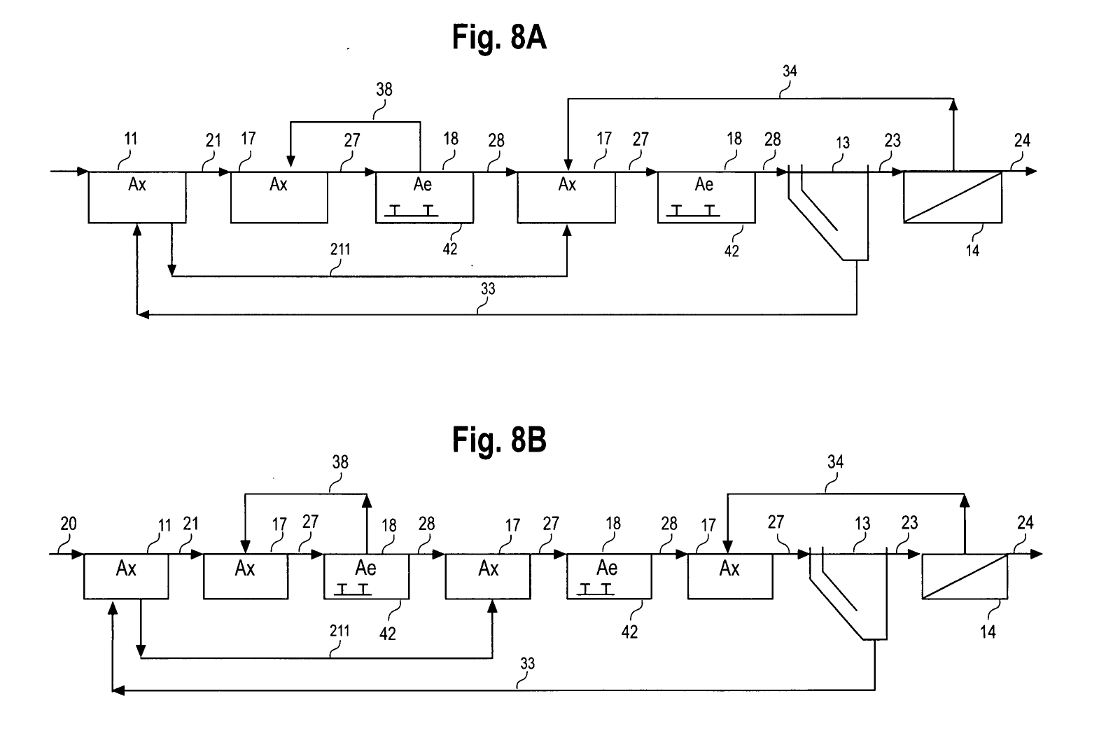

FIGS. 8A and 8B represent a conventional multi-stage flow-through activated sludge process which replaces the staged aeration basin with one or more individual aerobic 18 and anoxic 17 reactors between the anaerobic reactor 11 and the phase separator 13 prior to the membrane filter array 14. For clarity, multiple reactors of the same kind in a single schematic treatment path are ordered from the most upstream reactor (designated “first” or “primary”) sequentially to the most downstream reactor unless the location is otherwise described in relation to a reactor with a known location. In FIG. 8A, the influent to phase separator 13 comes from a secondary aerobic reactor 18 via channel 28. The effluent from aerobic reactor 18 is low in oxidized nitrogen, therefore solids discharged from the phase separator 13 through solids return line 33 are returned to anaerobic reactor 11 without the need for a pre-anoxic reactor 15 to condition returned solids as in conventional treatment techniques. The secondary anoxic reactor 17 may accept an additional organic carbon source to promote denitrification. If anoxic reactor 17 is upstream of a first aerobic reactor 18, the oxidized nitrogen source is preferably from the first aeration reactor 18 via recycle channel 38. If anoxic reactor 1.7 is downstream of the first aerobic reactor 18, the carbon source is preferably from anaerobic basin 11 via channel 211. Channel 211 is flow rate controlled by a pump or a valve or other means as are known in the art to deliver a low flow rate to the downstream anoxic basin 17, preferably at a rate of approximately 0.2 Q. In the embodiment of FIG. 8A, the discharge from phase separator 13 is preferably split so that channel 23 contains less than 30% of the solids and return channel 33 contains more than 70% of the solids. The high solids concentration in return channel 33 produces a low return flow rate, preferably in the range of 0.3 Q to 0.5 Q.

A typical example of a flow and solids balance of a preferred embodiment of the invention with respect to the configuration of FIG. 8A is described as follows. The embodiment of FIG. 8A begins with influent in channel 20 of 1 Q with 200 mg/l TSS and TKN=40 mg/l, and influent of return channel 33 of 0.63 Q at 21,000 mg/l MLSS for 1.63 Q total influent to anaerobic basin 11 at approximately 8,200 mg/l MLSS. At a one hour hydraulic residence time in anaerobic basin 11, the effluent in channels 21 and 211 will be approximately 8,200 mg/l MLSS. From anaerobic basin 11, 1.43 Q is conveyed via channel 21 to a first anoxic reactor 17 which also receives 1.5 Q from return channel 38 at 8,200 mg/l MLSS for a total of 2.93 Q into a first anoxic reactor 17 and aerobic reactor 18. The remaining 0.2 Q is conveyed via channel 211 to a second anoxic reactor 17. With hydraulic residence times of 1.5 hours in the first anoxic reactor 17 and 3.0 hours in aerobic reactor 18, channel 28 discharges 1.43 Q to second anoxic reactor 17 which also receives 0.5 Q return from the membrane tank 14 via channel 34 resulting in an MLSS of 6,400 mg/l. Following a 1.0 hour hydraulic residence time in second anoxic reactor 17, channel 27 conveys 2.13 Q at 6,400 mg/l MLSS to a secondary aerobic reactor 18 with a retention time of 1.0 hours. Optionally, the discharge from the second anoxic reactor may be passed directly to the phase separator 13 to reduce the treatment volume. Phase separator 13 discharges 1.49 Q to membrane reactor 14 at 200 mg/l MLSS and returns 0.64 Q at 21,000 mg/l MLSS to anaerobic reactor 11. Membrane reactor 14 discharges 1 Q in filtrate via channel 24 and recycles 0.5 Q at 600 mg/l MLSS via solids return channel 34 to the second anoxic reactor 17. Generally, the treatment process described above is operated to result in a hydraulic retention time of 8 hours and a sludge retention time of approximately 10-15 days.

In another embodiment, FIG. 8B shows a third anoxic reactor 17 with 0.5 hours detention placed between the secondary aerobic reactor 18 and the phase separator 13. In this embodiment, the return flow through channel 34 from membrane 14 is discharged into the third anoxic reactor 17. The option presented in FIG. 8B effectively limits the potential for oxygen introduction into the secondary anoxic reactor 17 as a means to improve denitrification in the system.

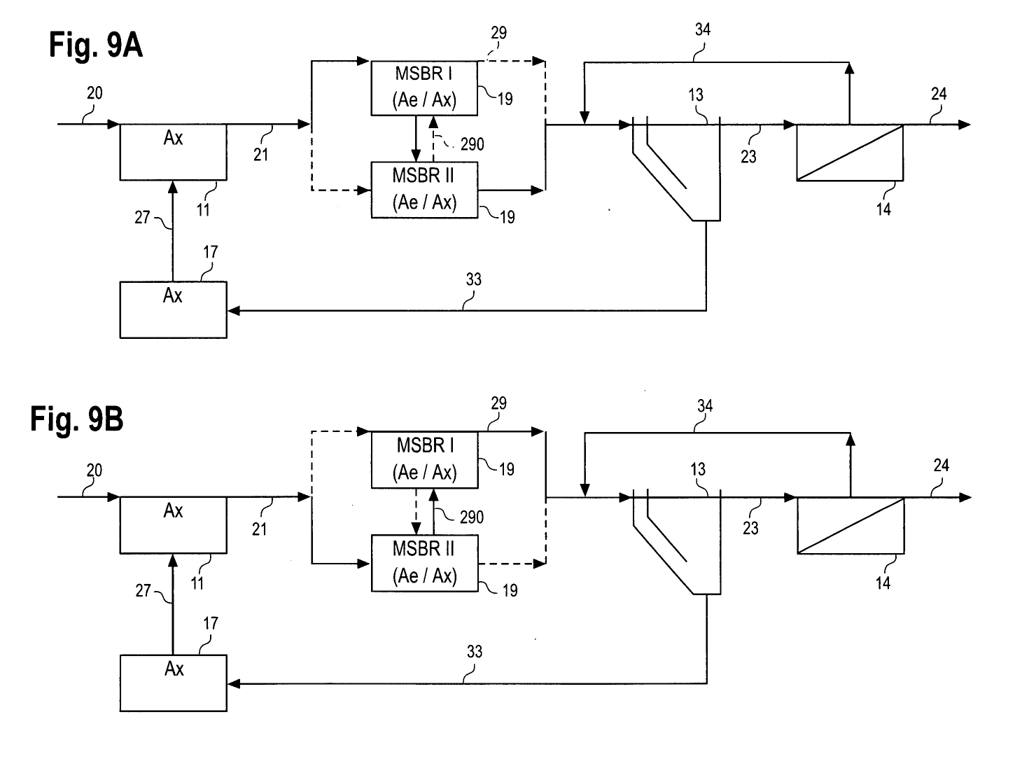

FIGS. 9 A&B and 10 A&B depict a modified sequencing batch reactor process where a first and second MSBR reactor 19 are operated in an alternating series configuration. In this operational mode, each MSBR reactor 19 receives continuous inflow and outflow resulting in a fixed water level. As with staged aeration reactor 12, each MSBR unit 19 is equipped with an aeration system 42 (not shown) which operates in the same manner as the aeration system of staged aeration reactor 12. The react phase of each MSBR unit 19 is operated in a manner consistent with the cycled sequence of aerobic and anoxic phases described for the staged aeration reactor 12.

In FIG. 9A, an anoxic reactor 17 is added between return solids channel 33 and the anaerobic reactor 11 to remove oxygen, reduce forms of oxidized nitrogen (nitrates and nitrites) and initiate volatile fatty acid production in the MLSS prior to introduction of the MLSS into the anaerobic reactor 11 via channel 27. Also, the first and second MSBRs 19 are cross connected by channels 290 to provide operational flexibility and additional flow equalization capability. The channels may be open (solid line) or closed (dashed line) as needed with appropriate gates, valves or other flow control equipment as is known in the art. Controls on the channels of FIGS. 9A&B may be either time based or probe based at the convenience of the operator. FIGS. 9A and 9B show the alternating flow paths through a pair of MSBRs designated MSBR I and MSBR II when certain channels are alternatively opened and closed. In the flow path of FIG. 9A, MSBR I operates with an elevated supply of carbon and other substrate in the wastewater (driving nutrient removal) while MSBR II provides polishing treatment. In FIG. 9B changes in the channels that are opened and closed reverse the roles of MSBR I and MSBR II.

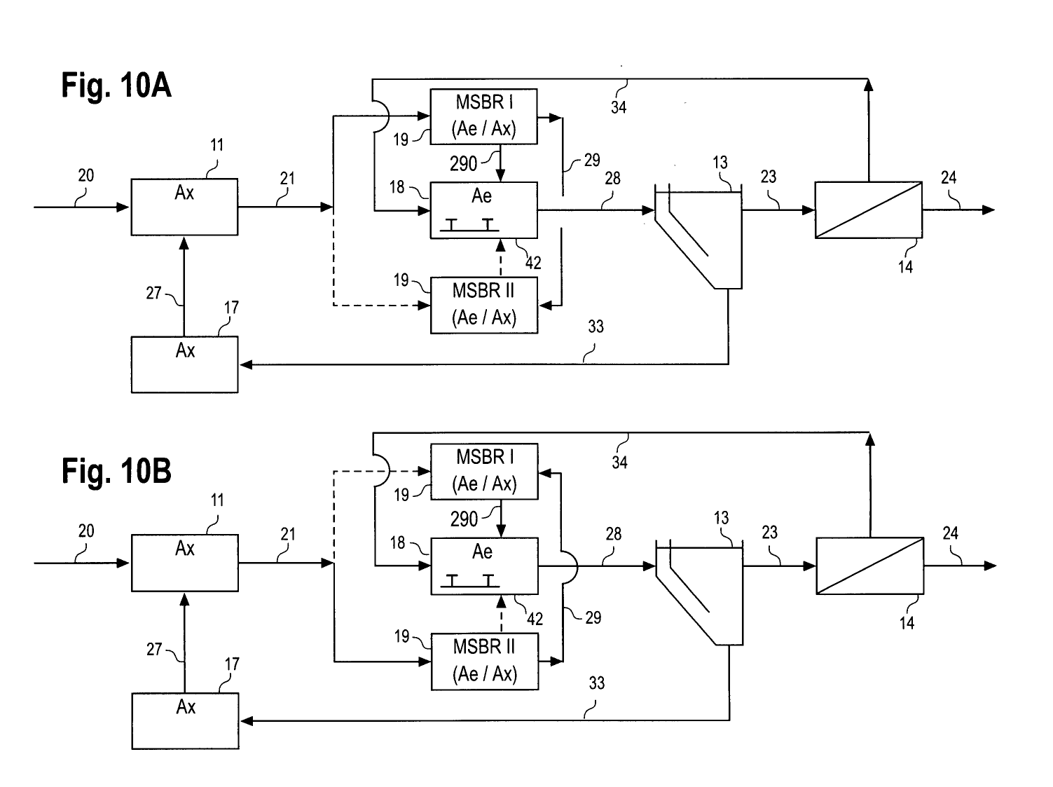

FIGS. 10A & B include the anoxic reactor 17 of FIGS. 9A & B and add an aerobic reactor 18 in communication with the MSBRs 19 and phase separator 13. Instead of returning the recycle from membrane reactor 14 directly to the MSBRs 19, solids return channel 34 first enters aerobic reactor 18 to provide a secondary biological oxidation step prior to introduction to the phase separator 13. Use of an aerobic reactor 18 offers a barrier of treatment which allows the MSBR reactors 19 to operate with a constant liquid level thereby reducing head-loss across the system. Channel 290 opens downstream of the second MSBR (alternatively MSBR I or MSBR II) to discharge into aerobic reactor 18.

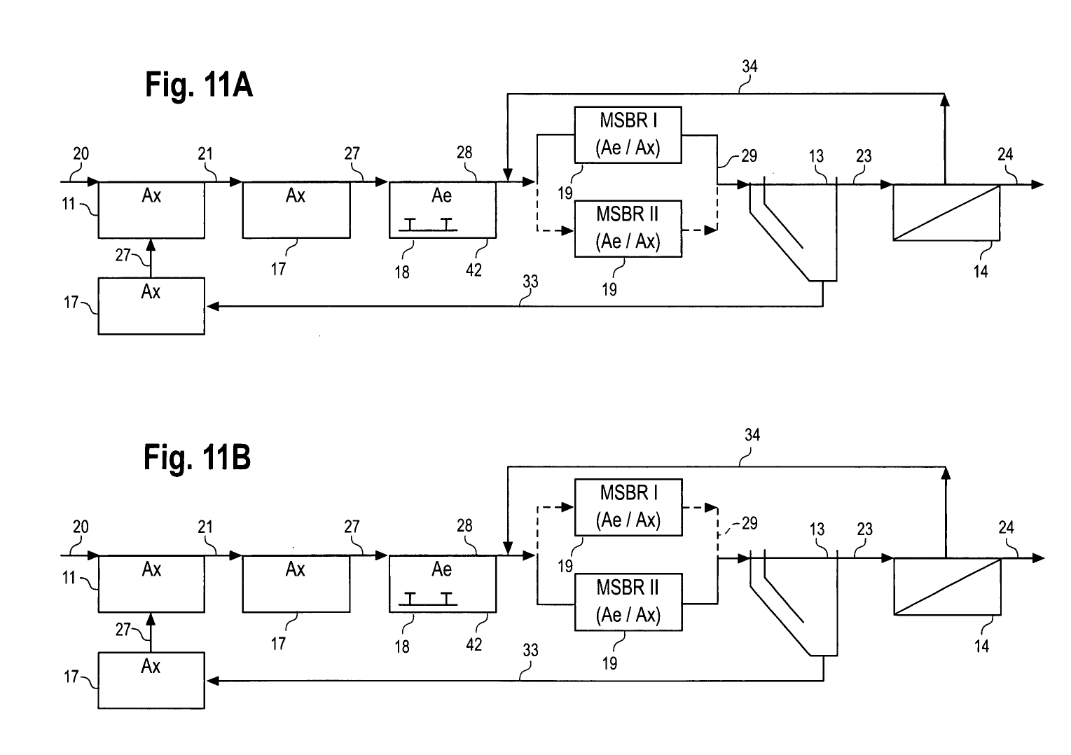

The flow-through treatment process embodiments of FIGS. 11A and 11B use a pair of MSBR reactors 19 downstream of an anaerobic reactor 11, anoxic reactor 17 and aerobic reactor 18 and upstream of the phase separator 13 and membrane reactor 14 in a configuration that allows for the isolation of an MSBR reactor 19 from the main line of treatment. FIG. 11A illustrates a process condition where the first of two MSBR reactors 19 is operating in continuous flow mode on the main line of treatment, while a second MSBR reactor 19 is hydraulically isolated from the line of treatment and is operating in batch mode. It is noted that an MSBR that is isolated from the main line of treatment and operated in batch mode is actually functioning temporarily in the same manner as a conventional SBR in that biological treatment can occur in the absence of incoming wastewater. FIG. 11B illustrates the second phase of the same treatment process wherein the second MSBR reactor 19 is operating in continuous flow mode on the main line of treatment, while the first MSBR reactor 19 is hydraulically isolated from the line of treatment and is operating in batch mode. Flow control equipment known in the art is employed to alternate between the treatment configurations of FIG. 11A and FIG. 11B.

As used herein, a MSBR reactor 19 is a treatment chamber equipped with mixing and aeration equipment, along with the control equipment necessary to operate the reactor alternatively in either batch mode or continuous mode. Each MSBR reactor is capable of performing the treatment steps of nitrification and denitrification with an added benefit of improved filterability characteristics attributed to the polishing treatment resultant from batch, isolated treatment. Therefore the MSBR applications described in FIGS. 11 A& B are more effective in terms of nitrate and nitrogen removal in comparison to the MSBR applications of FIGS. 9 A&B. However, the MSBR applications of FIGS. 9 A&B are considered to be more economical in terms of capital and operational costs than the MSBR applications described in FIGS. 11 A&B.

The system includes a primary anoxic reactor 17 in the main line of treatment and a secondary anoxic reactor 17 fed by the return channel 33 from the phase separator 13. In a typical operation of the system of FIGS. 11A and 11B, screened, raw influent is introduced to the anaerobic reactor 11 by the influent channel 20. The anaerobic reactor 11 also receives flow from the secondary anoxic reactor 17 via channel 27. Flow from the anaerobic reactor 11 is introduced to the primary anoxic reactor 17 through channel 21. In addition, recycle flow is received from the primary aerobic reactor 18 through return channel 38. The flow routed through channel 38 will be operator adjustable based upon the actual operating conditions. As known in the art, channel 38 functions as a nitrate and nitrite recycle line from a primary aerobic reactor 18. The ability of the primary anoxic reactor 17 to reduce the overall nitrate and nitrite levels is proportional to the ratio between the rate of flow in channel 38 to the incoming flow in channel 20. The flow in channel 38 will vary from 0 to 100% of the incoming raw flow depending upon the effluent nitrate and nitrite levels in conjunction with other anoxic actions taken in the MSBR reactors 19 and the secondary anoxic reactor 17.

The primary aerobic reactor 18 receives input from channel 27 while discharges include the nitrate/nitrite recycle 38 and discharge channel 28. A minimum of two MSBR reactors 19 will be fed sequentially through channel 28 in a manner that isolates cells for batch treatment while maintaining a constant water level. In this respect, the process schematic illustrated in FIGS. 11A and 11B offers hydraulic and design benefits attributed to flow-through processes with process conditioning advantages typically offered in batch type systems.

Similarly, discharge from the MSBR reactors 19 will be sequentially discharged to the phase separator 13 through channel 29. The phase separator 13 is sized to produce a high-solids stream which conveys more than 70% of the suspended solids mass to the secondary anoxic reactor 17 through channel 33. Conversely, the phase separator 13 also generates a low-solids stream where less than 30% of the suspended solids are introduced to the membrane tank 14 through channel 23. The permeate is discharged from membrane tank 14 through effluent channel 24. Suspended solids which are rejected by the membrane tank 14 are returned through channel 34 to the primary aeration basin's discharge channel 28.

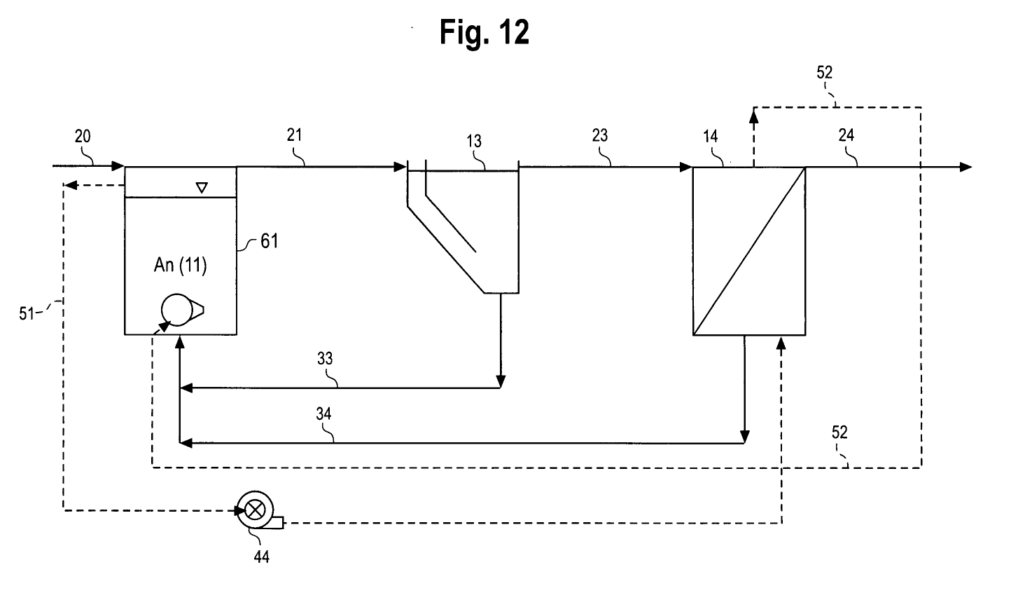

Another variation of the treatment processes generally described above with respect to FIGS. 1-3 is shown in FIG. 12. The treatment process of FIG. 12 is an anaerobic system that does not include an aeration step. Influent channel 20 conveys a wastewater to anaerobic reactor 11, which can be operated in either a batch or continuous-flow mode of operation. Effluent from anaerobic reactor 11 is conveyed via channel 21 to a phase separator 13. Also, gas (primarily methane) released during treatment in anaerobic reactor 11 is captured and conveyed to the membrane tank 14 by blower 44. The blower 44 and gas line 51 are of conventional design for anaerobic gas transfer in wastewater applications and employ materials and components which are well known in the art. Gas line 51 terminates at membrane tank 14 with a suitable diffuser or other means for producing bubbles of a size that are effective for scouring accumulated debris from the inlet side of the membranes.

The effluent from anaerobic reactor 11 is discharged to phase separator 13 via channel 21. As described in previous embodiments, the phase separator is used to reduce suspended solids loading to membrane tank 14 to lower the energy requirements within the membrane system. The membranes of this system can be of the submerged form or preferably modular rack systems such as those offered by Norit's Airlift™ MBR Membrane Technology. On the effluent side of membrane tank 14, the scouring gas is recovered via gas return line 52, which is routed back to anaerobic reactor 11 to complete a closed loop. It is understood that the collection and circulation of gas in the system of FIG. 12 may be accomplished by other configurations of blowers, piping, valves and control units as are known in the art.

Preferably, return channels 33 and 34, along with gas return line 52, are jointly connected to anaerobic reactor 11 via a jet nozzle 61. The use of jet nozzle 61 to combine recycle lines 33 and 34 with gas return line 52 substantially aids mixing of the return flows with the contents of anaerobic reactor 11. Alternatively, separate diffusers and supplemental mixers can be provided to convey all recycle flows and gas return.

The treatment process of FIG. 12 may be further modified to provide operation of anaerobic reactor 11 in a batch mode with a constant water level. In this variation, two anaerobic reactors arranged in parallel are connected to the main line of treatment with appropriate valves and controls that alternatively isolate either the first or second anaerobic reactor 11 from the treatment path.

The embodiments of FIG. 12 are typically applicable to highly variable industrial-strength wastewater, as opposed to domestic sewage. In such applications, the BOD can vary between, for example, 3000 mg/l and 30,000 mg/l BOD or higher and TSS between, for example, 0 mg/l and 50,000 mg/l TSS or higher. As a general approach, phase separator 13 may remove 70% of the TSS and 30% of the flow received from channel 21 through return channel 33. Conversely, the phase separator 13 may discharge approximately 30% of the TSS and 70% of the flow received from channel 21 through the discharge channel 23.

The above description is not intended to limit the meaning of the words used in or the scope of the following claims that define the invention. Rather, it is contemplated that future modifications in structure, function or result will exist that are not substantial changes and that all such insubstantial changes in what is claimed are intended to be covered by the claims. Thus, while preferred embodiments of the present inventions have been illustrated and described, it will be understood that changes and modifications can be made without departing from the claimed invention. In addition, although the term “claimed invention” or “present invention” is sometimes used herein in the singular, it will be understood that there are a plurality of inventions as described and claimed.

Various features of the present inventions are set forth in the following claims.

What is claimed is:

1. An activated sludge wastewater treatment method carried out in a wastewater treatment facility having in the main path of treatment an anaerobic reactor, a staged aeration reactor, a modified phase separator and a membrane reactor, said method comprising the steps of:
cycling an aerator in said staged aeration reactor between an on condition and an off condition in periodic time intervals;
discharging a first wastewater from said modified phase separator to said membrane filter, said first wastewater having a first MLSS concentration;
recycling a second wastewater from said modified phase separator to a location hydraulically upstream of said staged aeration reactor, said second wastewater having a second MLSS concentration; and
wherein said first MLSS concentration is less than or equal to 1,000 mg/l, and said second MLSS concentration is greater than or equal to 10,000 MLSS.

2. The method of claim 1 further comprising the steps of:
discharging a filtrate from said membrane reactor; and
recycling a retentate from said membrane reactor to a location hydraulically upstream of said staged aeration reactor;
wherein the flow rate of said retentate is less than twice the flow rate of said filtrate.

3. The method of claim 1 further comprising the step of scouring the membranes of said membrane reactor with air in the form of fine bubbles.

4. The method of claim 1 further comprising the step of scouring the membranes of said membrane reactor with a gas collected from said anaerobic reactor.

5. An activated sludge wastewater treatment method carried out in a wastewater treatment facility having in the main path of treatment a plurality of sequencing batch reactors, a modified phase separator and a membrane reactor, said method comprising the steps of:
discharging a first wastewater from said modified phase separator to said membrane filter, said first wastewater having a first MLSS concentration;
recycling a second wastewater from said modified phase separator to a location hydraulically upstream of said plurality of sequencing batch reactors, said second wastewater having a second MLSS concentration; and
wherein said first MLSS concentration is less than or equal to 1,000 mg/l, and said second MLSS concentration is greater than or equal to 10,000 MLSS.

6. The method of claim 5 further comprising the steps of:
discharging a filtrate from said membrane reactor; and
recycling a retentate from said membrane reactor to a location hydraulically upstream of said plurality of sequencing batch reactors;
wherein the flow rate of said retentate is less than twice the flow rate of said filtrate.

7. An activated sludge wastewater treatment method carried out in a wastewater treatment facility having in the main path of treatment a plurality of anoxic reactors, an aerobic reactor located hydraulically between the first and last of said plurality of anoxic reactors, a modified phase separator and a membrane reactor, said method comprising the steps of:
discharging a first wastewater from said modified phase separator to said membrane filter, said first wastewater having a first MLSS concentration;
recycling a second wastewater from said modified phase separator to a location hydraulically upstream of said plurality of anoxic reactors, said second wastewater having a second MLSS concentration; and
wherein said first MLSS concentration is less than or equal to 1,000 mg/l, and said second MLSS concentration is greater than or equal to 10,000 MLSS.

8. The method of claim 7 further comprising the steps of:
discharging a filtrate from said membrane reactor; and
recycling a retentate from said membrane reactor to a location hydraulically upstream of said plurality of anoxic reactors;
wherein the flow rate of said retentate is less than twice the flow rate of said filtrate.

9. An activated sludge wastewater treatment method carried out in a wastewater treatment facility having in the main path of treatment a plurality of hybrid reactors, a modified phase separator and a membrane reactor, said method comprising the steps of:
discharging a first wastewater from said modified phase separator to said membrane filter, said first wastewater having a first MLSS concentration;
recycling a second wastewater from said modified phase separator to a location hydraulically upstream of said plurality of hybrid reactors, said second wastewater having a second MLSS concentration; and
wherein said first MLSS concentration is less than or equal to 1,000 mg/l, and said second MLSS concentration is greater than or equal to 10,000 MLSS.

10. The method of claim 9 further comprising the steps of:
discharging a filtrate from said membrane reactor; and
recycling a retentate from said membrane reactor to a location hydraulically upstream of said plurality of hybrid reactors;
wherein the flow rate of said retentate is less than twice the flow rate of said filtrate.

11. The method of claim 9 further comprising the step of operating said plurality of hybrid reactors in batch mode.

12. The method of claim 9 further comprising the step of operating said plurality of hybrid reactors in continuous mode.

13. A sludge degradation wastewater treatment method carried out in a wastewater treatment facility having in the main path of treatment an anaerobic reactor, a modified phase separator and a membrane reactor, said method comprising the steps of:
discharging a first wastewater from said modified phase separator to said membrane filter, said first wastewater having a first MLSS concentration;
recycling a second wastewater from said modified phase separator to a location hydraulically upstream of said anaerobic reactor, said second wastewater having a second MLSS concentration; and
wherein said first MLSS concentration is less than or equal to 1,000 mg/l, and said second MLSS concentration is greater than or equal to 10,000 MLSS.

14. The method of claim 13 further comprising the steps of:
discharging a filtrate from said membrane reactor; and
recycling a retentate from said membrane reactor to a location hydraulically upstream of said anaerobic reactor;
wherein the flow rate of said retentate is less than twice the flow rate of said filtrate.

15. The method of claim 13 further comprising the step of scouring the membranes of said membrane reactor with a gas collected from said anaerobic reactor.

16. The method of claim 14 further comprising the step of scouring the membranes of said membrane reactor with a gas collected from said anaerobic reactor.

17. The method of claim 16, further comprising the step of mixing said second wastewater, said retentate and said gas together before returning the flow to said anaerobic reactor.
